(19) United States
(12) Patent Application Publication
(10) Pub. No.: US 2006/0012976 A1
(43) Pub. Date: Jan. 19, 2006

(54) String lamp cap

(76) Inventor: Chao Chin Chen, Taipei Hsieh (TW)

Correspondence Address: CHARLES E. BAXLEY, ESQ., 90 JOHN STREET, THIRD FLOOR, NEW YORK, NY, 10038, US

(21) Appl. No.: 10/892,685

(22) Filed: Jul. 15, 2004

(51) Int. Cl. F21V 21/084

(52) U.S. Cl. 362/106

(57) ABSTRACT

The present invention involves to a string lamp cap, which includes a transparent cup with an open mouth, and a holding ring with at least one cramping clip, wherein said transparent cup has a stepped hole at the open mouth for spacing said holding ring, for locating the holding ring, several lugs are built upon the side wall of said stepped hole cooperating to the stopping end of it to form a ring groove, and said cramping clip of the holding ring provides a socket for holding the bulb base. Due to utilizing above-mentioned structure, the present invention facilitates to replace bulb, and can be used individually and simply to cooperate to the string lamp in open garden, and also combines into the inside of balloon or inflated doll working as a good isolation efficiently prevent the surface of the bulb from touching against the shell and burning and striking, further to improve the safety of the goods.

### BACKGROUND OF THE INVENTION

1. Field of the Invention

The present invention relates to a string lamp cap.

2. Description of Prior Art

The flashing string lamp creates decorated effect as star sky in the night, so it often is used for ornamenting festal celebration, commercial advertise and some places making play of warm atmosphere. In practice, besides hanging up in common state, it also is embedded into the inside of balloon or inflated doll so as to light the inside after inflated for improving showing effect, but this structure exists some shortcomings as followings:
1. Said bulbs are located at inside of inflated doll in fixed connection, once if one of them is burned or damaged, it is difficult to be replaced so that the product lose lighting function;
2. The embedded string lamps are not isolated from the shell with any mater or protection, so that once if the air at inside is to escape any more or stroke from outside, the surface of the bulb maybe touch against the shell to occur cremating or damaging the shell, further to make it not able to be used continuously.

On the other hand, side opening hanging in use exists some shortcomings: such like most of them are hung over the nails, or up in sticking with stick strap, or over branch of tree or rape or wall in cramping with some clips, but once laying over the grass they are arranged by will, and due to no any protection for shielding or decorating, except lack beautification, and they are easy to be damaged by treading on, the safety in use is not guaranteed, due to lacking efficient isolation and pad, therefore the sprayed water or rain and dew are easy to seep into the inside to bring to leak electricity.

### OBJECTS AND SUMMARY OF THE INVENTION

For overcoming the above said shortcomings of the prior art, it is therefore a main object of the present invention to provide a string lamp cap so as to facilitating replacing bulb, and which can be used individually and simply to cooperate to the string lamp in open garden, and also embedded into the inside of balloon or inflated doll working as a good isolation efficiently prevent the surface of the bulb from touching against the shell and burning and striking, further to improve the safety of the goods.

This object is achieved by a string lamp cap provided of the present invention, within said cap includes a transparent cup with an open mouth, and a holding ring with at least one cramping clip, wherein said transparent cup has a stepped hole at the open mouth for spacing said holding ring, for locating the holding ring, several lugs are built upon the side wall of said stepped hole cooperating to the stopping end of it to form a ring groove, and said cramping clip of the holding ring provides a socket for holding the bulb base.

Due to utilizing above-mentioned structure, facilitate to replace bulb, and which can be used individually and simply to cooperate to the string lamp in open garden, and also embedded into the inside of balloon or inflated doll working as a good isolation efficiently prevent the surface of the bulb from touching against the shell and burning and striking, further to improve the safety of the goods.

### BRIEF DESCRIPTION OF THE DRAWINGS

FIG. 1 is an exploded view of the string lamp cap.

FIG. 2 is a solid view showing the combination with the bulb of the string lamp cap.

FIG. 3 is a sectional view showing the combination state of the present invention.

FIG. 4 is a scheme showing an inflated doll lighted by the apparatus shown in FIG. 3 of the present invention.

### DETAILED DESCRIPTION OF PREFERRED EMBODIMENTS

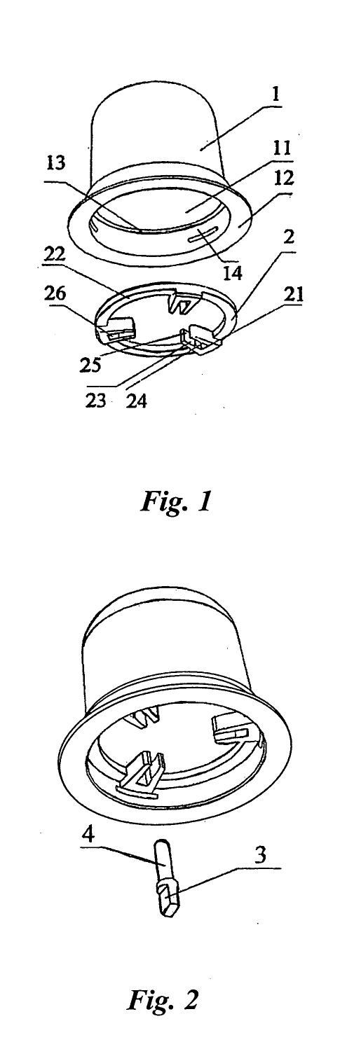

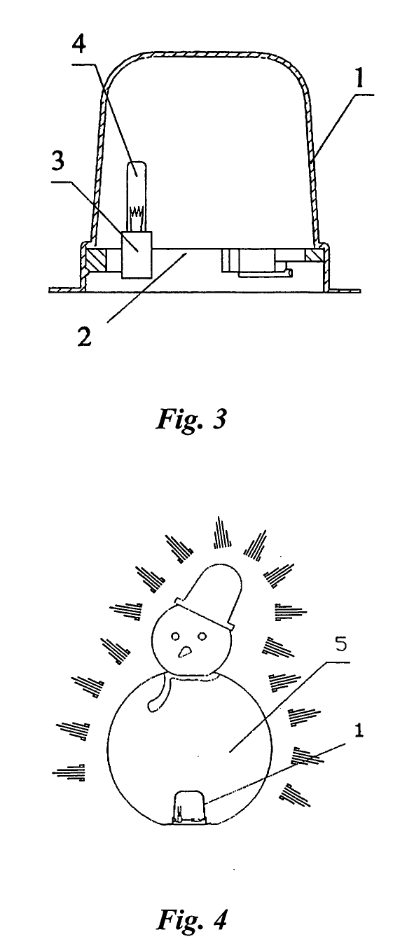

Referring to FIG. 1 to FIG. 3, the string lamp cap of the present invention includes a transparent cup 1 and a holding ring 2, wherein said transparent cup 1 has an open mouth 11 with a flange 12 at the rim to the outside and a stepped hole with a stopping end 13 at inside of it; said holding ring 2 is a ring 22, thereby fitting in the stepped hole and locating on the stopping end 13, there are three cramping clips 21 built upon the ring 22 in uniform distribution (the number of the cramping clips 21 can be increased or decreased depending on the necessary of intension of light); cooperating to the stopping end 13 of the transparent cup 1, there are three lugs coordinating to the three cramping clips 21 of the holding ring 2 to form a ring groove 14 for catching at the cramping clips 21; said cramping clip 21 provides a socket 23 for holding the bulb base 3 in; for this purpose, the sectional area of the socket 23 is a bit smaller than the bulb base 3, within two opposite open notches 24 25 set upon the socket 23, coordinating to it a through hole 26 is built upon the cramping clip 21 and connects to the socket 23 via the notch 24. The three cramping clips 21 uniform space aligned in the holding ring 2 keeps bigger spaces between them for facilitating to cool. And the bulbs used in the present invention are cool-light sources, so the heat given out is not much so that the transparent cup 1 is not to be damaged.

On another embodiment, the cramping clip 21 just only has a socket 23 for holding the bulb base 3 with an open notch 25, within the sectional area of the socket 23 smaller than the bulb base's 3. Coordinating to the stopping end of the transparent cup 1, a inner collar is built upon to form a locating groove 14 for catching at the cramping clips 21 of the holding ring 2.

Referring to FIG. 2 to FIG. 4, said transparent cup 1 has an open mouth 11 with a flange 12 at the rim to the outside for connecting to the different styles of inflated dolls 5 or balloons, in practice, the transparent cup 1 is pre-embedded into the inside of the inflated doll 5 or balloon, according to the size of the inflated doll 5 or balloon, one or proper number of the transparent cups 1 are employed, in the idle time, the bulb base 3 is not installed on the holding ring 2, but as wanting to use, the holding ring 2 is forced into the ring groove 14 to catch up, then press the bulb base 3 into the socket 23 through the open notch 25 so as to be held in, in order that the bulbs 4 are isolated from the air-bag of the inflated doll 5 or balloon as they are inflated, further to avoid the bulbs 4 breaking by expected striking or the air-bag burning as contacting occurred by leaking some inflated air; and when the bulbs 4 are lighted, because the bigger intervals between them provide good cool condition, and once if the bulb 4 is broken down, by the backward sequence operation the broken bulb 4 is easy to be replaced rapidly, therefore the service life of the product is delayed greatly.

The present invention not only combines into inflated dolls 5 or balloons, but also individually is used as the cap of string lamp to work as wall lamp or garden lamp; in practice, the transparent cup 1 is modified bigger than the common string lamp, by means of the flange 12 facilitate to combine with inflated dolls 5 or balloons, or hung over in proper position as same as conventional string lamp or laid over the ground in alignment, so as to overcome the disordered alignment shortcoming of the conventional string lamp, meanwhile the bulb base 3 is efficiently isolated and spaced up for avoiding the string lamp happening electricity leak occurred by seeped water.

I claim:

1. A string lamp cap including a transparent cup with an open mouth, wherein it also includes a holding ring that at least includes one cramping clips, said transparent cup has a stepped hole at the open mouth for spacing said holding ring, for locating the holding ring, several lugs are built upon the side wall of said stepped hole cooperating to the stopping end of it to form a ring groove, and said cramping clip of the holding ring provides a socket for holding the bulb base.

2. A string lamp cap as claimed in claim 1, wherein said lugs are built as ribs coordinating to the positions of the cramping clips for catching them up in place.

3. A string lamp cap as claimed in claim 1, wherein said lugs are formed an inner collar to form a ring groove with the stopping end for catching the cramping clips in.

4. A string lamp cap as claimed in claim 1, wherein the sectional area of the socket of the cramping clip is a bit smaller than the bulb base, and said socket has an open notch.

5. A string lamp cap as claimed in claim 1, wherein said cramping clip provides a socket for holding the bulb base in; for this purpose, the sectional area of the socket is a bit smaller than the bulb base, within two opposite open notches set upon the socket, coordinating to it a through hole is built upon the cramping clip and connects to the socket via a notch.

6. A string lamp cap as claimed in claim 1, wherein said transparent cup has a flange at the rim of the open mouth outward.
